(19) United States
(12) Patent Application Publication
(10) Pub. No.: US 2015/0134239 A1
(43) Pub. Date: May 14, 2015

(54) SYSTEM AND METHOD FOR SEARCHING VEHICLE

(71) Applicant: HON HAI PRECISION INDUSTRY CO., LTD., New Taipei (TW)

(72) Inventor: MENG-YU HO, New Taipei (TW)

(73) Assignee: HON HAI PRECISION INDUSTRY CO., LTD., New Taipei (TW)

(21) Appl. No.: 14/194,904

(22) Filed: Mar. 3, 2014

(30) Foreign Application Priority Data
Nov. 14, 2013 (TW) 102141498

(51) Int. Cl. G01C 21/34; G01C 21/36

(52) U.S. Cl. CPC G01C 21/34; G01C 21/36
USPC 701/431; 701/461

(57) ABSTRACT

A method for searching a vehicle is provided. The method includes the following steps: determining whether or not there is a searching instruction from the vehicle locking device; acquiring the current position information of the vehicle locking device from the positioning unit when there is the searching instruction from the vehicle locking device; and calculating a route from a current position to an initial position according to the current position information, the initial position information, and the map information. A system for searching the vehicle is also provided.

### BACKGROUND

1. Technical Field

The present disclosure relates to systems, and particularly to a system and a method for searching a vehicle.

2. Description of Related Art

Sometimes it is difficult for a user to find a car when the car is parked in a parking lot and an area of the parking lot is large.

Therefore, what is needed is a system and a method for searching the vehicle to overcome the above described limitations.

### BRIEF DESCRIPTION OF THE DRAWING

FIG. 1 is a schematic diagram of an embodiment of a system for searching a vehicle.

FIG. 2 is a block diagram of an embodiment of a hardware infrastructure of the system.

FIG. 3 is flowchart of an embodiment of a method of searching a vehicle implemented by the system of FIG. 1.

### DETAILED DESCRIPTION

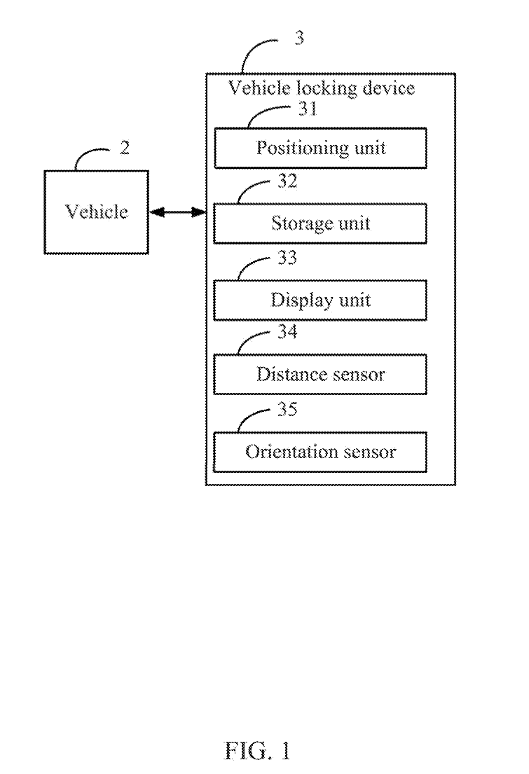

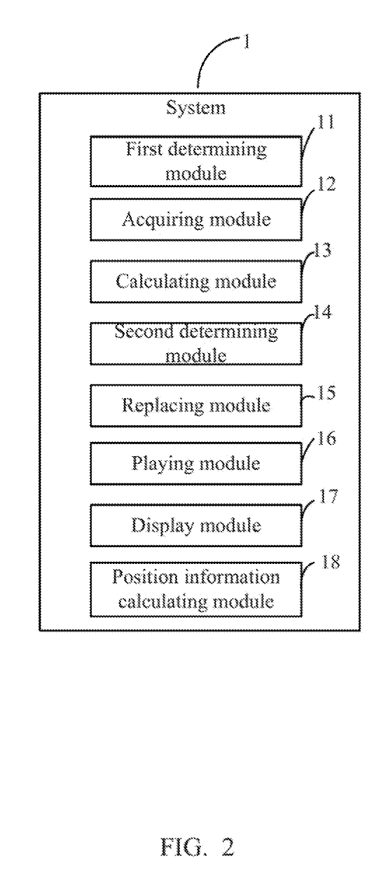

Referring to FIGS. 1-2, a system 1 for searching for a vehicle is provided. The system 1 is applied in a hardware environment which includes a vehicle 2 and a vehicle locking device 3. The vehicle locking device 3 is used to lock/unlock the vehicle 2 in response to a user operation. The vehicle locking device 3 includes a positioning unit 31, a storage unit 32, and a display unit 33. The positioning unit 31 provides current position information of the vehicle locking device 3. The storage unit 32 stores map information and initial position information of the vehicle locking device 3. The initial position information corresponds to a position where the vehicle 2 parks.

The system 1 includes a number of modules which are a collection of software instructions executed by one or more processors. The number of modules includes a first determining module 11, an acquiring module 12, and a calculating module 13.

The first determining module 11 determines whether or not there is a searching instruction from the vehicle locking device 3. The acquiring module 12 acquires the current position information of the vehicle locking device 3 from the positioning unit 31 when there is searching instruction from the vehicle locking device 3. The calculating module 13 calculates a route from a current position to an initial position according to the current position information, the initial position information, and the map information. In one embodiment, the first determining module 11, the acquiring module, and the calculating module run in the vehicle locking device 3.

The number of modules can further include a second determining module 14 and a replacing module 15. The second determining module 14 determines whether the vehicle 2 is in a parking state. In one embodiment, the second determining module determines a velocity of the vehicle, and determines whether the velocity of the vehicle reduces to 0, and the velocity of the vehicle remains at 0 for a predetermined time. If so, the vehicle 2 is in the parking state, otherwise, the vehicle 2 is in a moving state. In another embodiment, the second determining module 14 can determine whether a distance of a movement of the vehicle 2 is 0. If so, the vehicle 2 is in the parking state, otherwise, the vehicle 2 is in the moving state. The acquiring module 12 acquires the current position information of the vehicle locking device 3 from the positioning unit 31 when the vehicle 2 is in the parking state. The replacing module 15 replaces the initial position information of the vehicle locking device 3 in the storage unit 32 with the acquired current position information. In one embodiment, the second determining module 14 runs in the vehicle 2, and the replacing module 15 runs in the vehicle locking device 3.

The number of modules can further include a playing module 16. The playing module 16 plays a voice about the route. In one embodiment, the playing module 16 runs in the vehicle locking device 3.

The number of modules can further include a display module 17. The display module 17 displays the route on the display unit 33. In one embodiment, the display module 17 runs in the vehicle locking device 3.

The number of modules can further include a position information calculating module 18. The vehicle locking device 3 includes a distance sensor 34 and an orientation sensor 35. The distance sensor 34 senses a distance of a movement of the vehicle locking device 3. The orientation sensor 35 senses an orientation of the vehicle locking device 3. The position information calculating module 18 calculates position information of the vehicle locking device 3 using dead reckoning technology based on the sensed distance and the orientation of the vehicle locking device 3 when the positioning unit 31 does not precisely provide the current position information of the vehicle locking device 3.

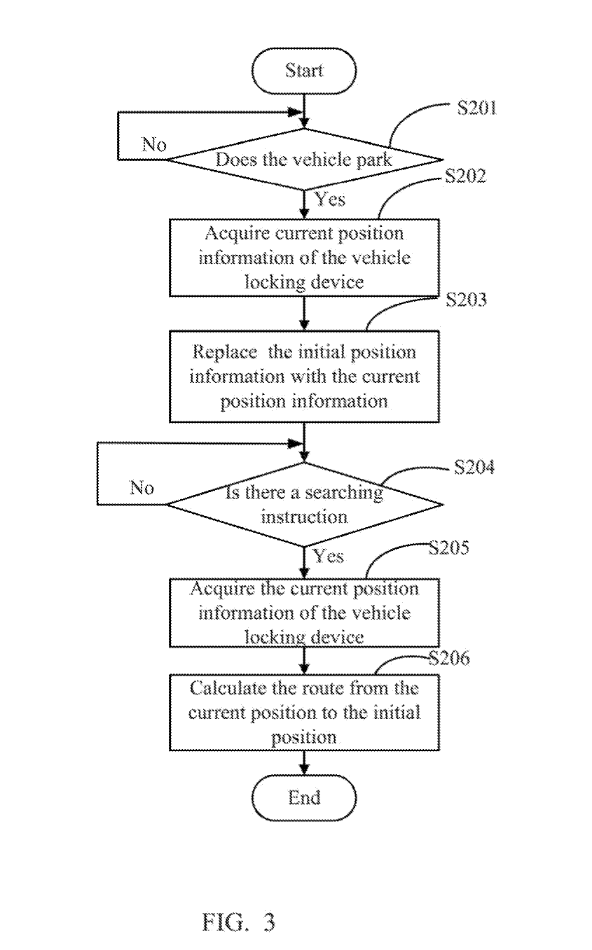

FIG. 3 is flowchart of an embodiment of a method of searching a position of a vehicle implemented by the system of FIG. 1.

In step S201, the second determining module 14 determines whether or not the vehicle 2 is in the parking state. If so, the procedure goes to step S202, otherwise, the procedure goes to step S201.

In step S202, the acquiring module 12 acquires the current position information of the vehicle locking device 3 from the positioning unit 31.

In step S203, the replacing module 15 replaces the initial position information of the vehicle locking device 3 with the acquired current position information.

In step S204, the first determining module 11 determines whether or not there is searching instruction from the vehicle locking device 3. If so, the procedure goes to step S205, otherwise, the procedure goes to step S204.

In step S205, the acquiring module 12 acquires the current position information of the vehicle locking device 3 from the positioning unit 31.

In step S206, the calculating module 13 calculates the route from the current position to the initial position based on the current position information, the initial position information, and the map information.

The method can further include: the playing module 16 plays a voice about the route, the display module 17 displays the route on the display unit 33, and the position information calculating module 18 calculates position information of the vehicle locking device 3 using a dead reckoning technology based on the sensed distance and the orientation of the vehicle locking device 3 when the positioning unit 31 cannot precisely provide the current position information of the vehicle locking device 3.

Although various embodiments have been specifically described, the disclosure is not to be construed as being limited thereto. Various changes or modifications may be made to the embodiments without departing from the scope and spirit of the disclosure.

What is claimed is:

1. A system for searching a vehicle with a vehicle locking device, the vehicle locking device to lock and unlock the vehicle in response to a user operation, and comprising a positioning unit and a storage unit, the positioning unit to provide current position information of the vehicle locking device, the storage unit to store map information and initial position information of the vehicle locking device, the initial position information corresponding to a position where the vehicle parks, the system comprising at least one processor and a plurality of modules to be executed by the at least one processor, wherein the plurality of modules comprises:
a first determining module configured to determine whether or not there is a searching instruction from the vehicle locking device;
an acquiring module configured to acquire the current position information of the vehicle locking device from the positioning unit when the searching instruction from the vehicle locking device is present; and
a calculating module configured to calculate a route from a current position to an initial position according to the current position information, the initial position information, and the map information.

2. The system as described in claim 1, wherein the plurality of modules further comprises:
a second determining module configured to determine whether or not the vehicle is in a parking state;
an acquiring module configured to acquire the current position information of the vehicle locking device from the positioning unit when the vehicle is in the parking state; and
a replacing module configured to replace the initial position information of the vehicle locking device in the storage unit with the acquired current position information.

3. The system as described in claim 1, wherein the plurality of modules further comprises a playing module configured to play a voice about the route.

4. The system as described in claim 1, wherein the plurality of modules further comprises a display module configured to display the route.

5. The system as described in claim 1, wherein the plurality of modules further comprises a position information calculating module configured to calculate position information of the vehicle locking device using a dead reckoning technology based on a distance of a movement of the vehicle and an orientation of the vehicle locking device when the positioning unit does not precisely provide the current position information of the vehicle locking device.

6. A method for searching a vehicle with a vehicle locking device, the vehicle locking device to lock and unlock the vehicle in response to a user operation, and comprising a positioning unit and a storage unit, the positioning unit to provide current position information of the vehicle locking device, the storage unit to store map information and initial position information of the vehicle locking device, the initial position information corresponding to a position where the vehicle parks, the method comprising:
determining whether or not there is a searching instruction from the vehicle locking device;
acquiring the current position information of the vehicle locking device from the positioning unit when the searching instruction from the vehicle locking device is present; and
calculating a route from a current position to an initial position according to the current position information, the initial position information, and the map information.

7. The method as described in claim 6, further comprising:
determining whether or not the vehicle is in a parking state;
acquiring the current position information of the vehicle locking device from the positioning unit when the vehicle is in the parking state; and
replacing the initial position information of the vehicle locking device in the storage unit with the acquired current position information.

8. The method as described in claim 6, further comprising playing a voice about the route.

9. The method as described in claim 6, further comprising displaying the route.

10. The method as described in claim 6, further comprising calculating position information of the vehicle locking device using a dead reckoning technology based on a distance of a movement of the vehicle and an orientation of the vehicle locking device when the positioning unit does not precisely provide the current position information of the vehicle locking device.
